(19) United States
(12) Patent Application Publication
(10) Pub. No.: US 2011/0250934 A1
(43) Pub. Date: Oct. 13, 2011

(54) CHARGING WHILE WIRELESS

(76) Inventor: Nicholas Clark, Sacramento, CA (US)

(21) Appl. No.: 12/758,359

(22) Filed: Apr. 12, 2010

(51) Int. Cl. H04W 52/00

(52) U.S. Cl. 455/573

(57) ABSTRACT

The present invention in several embodiments is a system that allows users to charge the battery of their cell phone without having to utilize traditional means. The present invention gives cell phone users the opportunity to charge their phone's battery utilizing a wireless router or other RF source. This product may virtually eliminate calls being ruined or dropped because of a dying battery. Using this innovative item, multiple consumers will be able to charge their cell phones at the same time. Anyone can use Charging While Wireless to keep their cell phone battery full without having to waste time plugging in the device.

### FIELD OF THE INVENTION

This invention generally pertains to wireless energy transmission. Specifically, the present invention relates to a system for charging batteries of wireless devices without the need for a wired connection to an electric source. More specifically, the present invention relates to a system for capturing radio frequency (RF) energy for charging an electrical device.

### BACKGROUND OF THE INVENTION

The invention is particularly applicable to telecommunication arts and will be described with particular reference thereto.

Having to search for an electrical outlet in order to plug in a cell phone to charge can be difficult. Many outlets may be occupied by other devices such as televisions, lamps or computers. A typical household may have multiple cell phone owners that need to charge their phone's battery. This could have several outlets being employed at once. This can have a person encountering a higher electric bill. It can also be time consuming for a person to have to sit and wait for their phone to charge after the battery has been completely drained.

### SUMMARY OF THE INVENTION

The present invention in several embodiments is a system that allows users to charge the battery of their cell phone without having to utilize traditional means. This product may virtually eliminate calls being ruined, or dropped because of a dying battery. Using this innovative item, multiple consumers will be able to charge their cell phones at the same time. Anyone can use Charging While Wireless to keen their cell phone battery full without having to waste time plugging in the device.

The present invention gives cell home users the opportunity to charge their phone's battery by utilizing a wireless router or other RF source. This product may have two different variations. The first design may have cell phone batteries with specialized chips installed inside. A wireless router, similar to the variety used for wireless Internet, will charge the battery. This is may be done constantly for a fully charged battery as long as the phone is within a predetermined proximity. Another variation of this product may have a wireless air card being inserted into a small slot on the side of the cell phone. The wireless router will then charge the air card, in turn charging the phone's battery. The exact components and method of operation at the present invention may vary upon manufacturing. However U.S. Pat. No. 7,084,605 is incorporated by reference and provides several routes to practicing the several embodiments of the present invention.

### OBJECTS OF THE INVENTION

It is, therefore, one of the primary objects of the present invention is to provide an improved wireless battery charging system.

Another object of the present invention is to provide wireless charging system that uses energy from commonly used telecommunication frequencies to obtain power.

Still another object of the present invention is to provide a system for easily enabling an electronic device to harvest energy from RF energy in the atmosphere.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a general perspective view of one embodiment of the present invention.

FIG. 2 is a general perspective view of a battery of a preferred embodiment of the present invention.

FIG. 3 is a general perspective view of a preferred embodiment of the invention.

FIG. 4 is a general perspective view of a preferred embodiment of the invention.

FIG. 5 is a general perspective view of a preferred embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

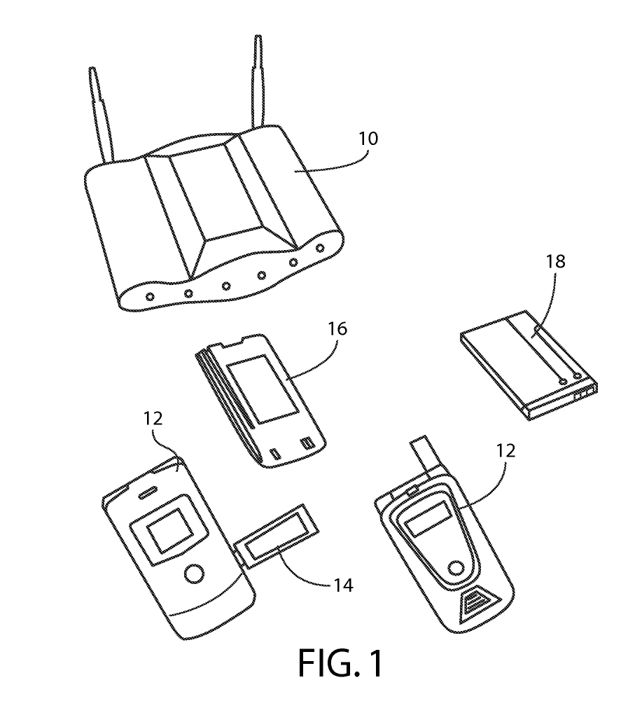

Reference is now made to FIG. 1 which shows a general perspective view of one embodiment of the present invention. The present invention is a system for wirelessly charging portable devices. In several embodiments the system my comprise a wireless router 10, at lease one cell phone 12, a wireless air card 14, a battery 16 and a RF harvesting battery 18.

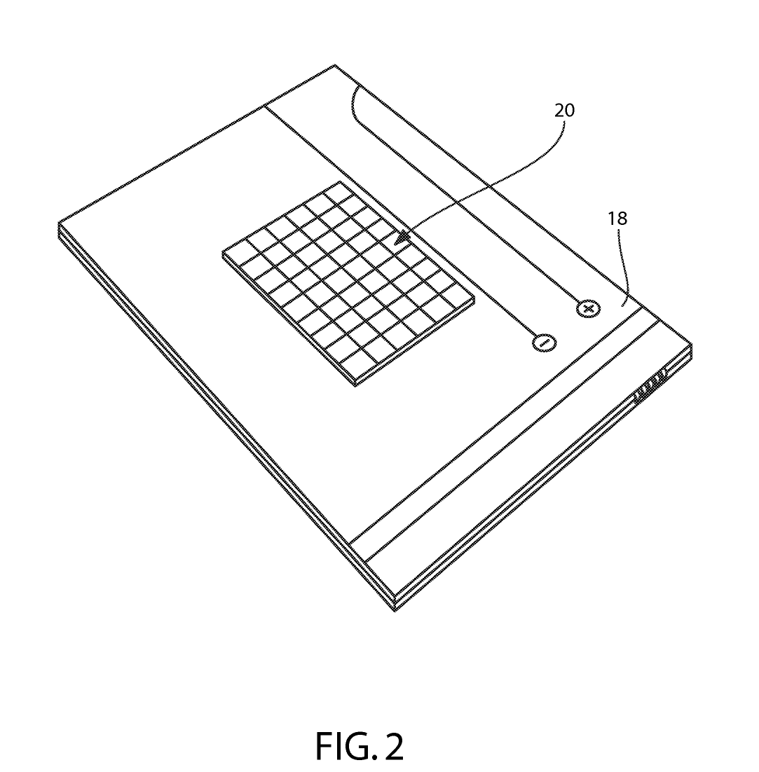

Reference is now made to FIG. 2 which shows a general perspective view of a RF harvesting battery 18. The RF harvesting battery 18 comprises an energy harvesting device 20 for harvesting energy from the environment which is electrically coupled to the battery 18. The energy harvesting device 20 transfers harvested energy to the battery 18 for storage and later use. The energy harvesting device 20 could be any device or apparatus for wirelessly collecting, harvesting or transferring energy known in the art. The energy harvesting device 20 could comprise induction coils, rectifiers, unimolecular rectifiers, antennas, charge pumps, tuning circuitry, etc. Arrays of such structures or devices could be beneficial in improving the energy harvesting capabilities of the system. The energy harvesting device 20 could be designed to harvest from a wide range of electromagnetic energies and also be optimized for specific frequencies of electromagnetic energies. Frequencies between 2 GHz and 6 GHz would be particularly important, since this would include frequencies used in many wireless communications bands.

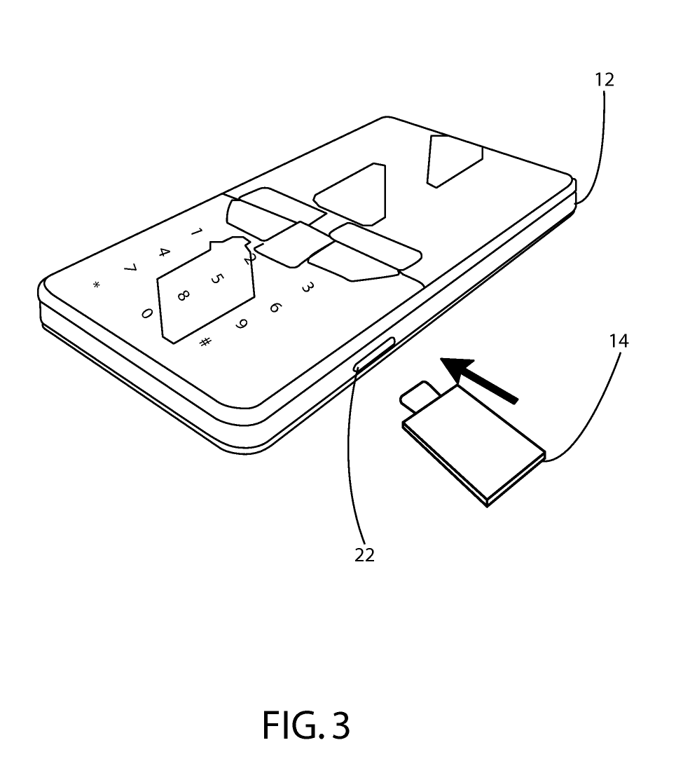

Reference is now made to FIG. 3 which shows a general perspective view of a wireless air card 14 being used with cell phone 12. The wireless air card 14 is inserted into slot 22 of cell phone 12. Slot 22 is connected to means for electrically coupling air card 14 to battery 16 of cell phone 12. Air card 14 comprises an energy harvesting device 20 for harvesting electromagnetic energy from the environment.

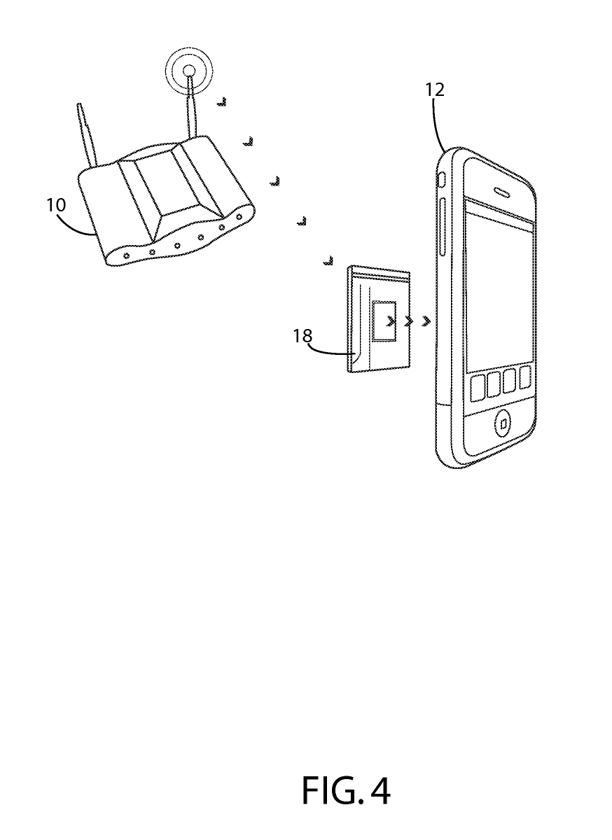

Reference is now made to FIG. 4 which shows a general perspective view of one embodiment of the present invention. In this embodiment of the invention, router 10 transmits a RF signal that RF harvesting battery 18 can collect energy from for storage. RF harvesting battery 18 can then be installed in cell phone 12 for use. RF harvesting battery 18 could be installed into cell phone 12 while harvesting energy as well. The described system could have means for detecting the need to charge RF harvesting battery 18, and then increase the power output of the router 10 by means of amplification, increased transmissions, or the like from the router. Also, RF harvesting battery 18 could collect energy from other electromagnetic signal in the environment such as radio signals, electromagnetic filed activity, or other electromagnetic radiation.

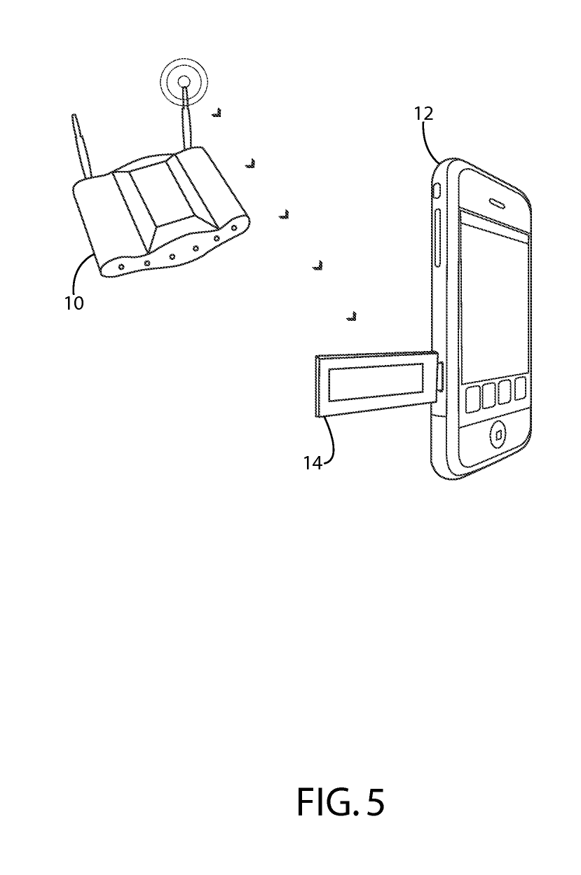

Reference is now made to FIG. 5 which shows a general perspective view of one embodiment of the present invention. In this embodiment of the invention, router 10 transmits a RF signal that air card 14 can collect energy from for storage in battery 16 (not shown). The described system could have means for detecting the need to charge battery 16, and then increase the power output of the router 10 by means of amplification, increased transmissions, or the like from the router 10. Also, air card 14 could collect energy from other electromagnetic signal in the environment such as radio signals, electromagnetic filed activity, or other electromagnetic radiation. Thus, allowing portable devices to be charged without any synchronization or unlocking of telecommunication systems or networks.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. An electronic system comprising:
at least one battery,
at least one energy harvesting device in electrical communication with said at least one battery,
wherein said at least one energy harvesting device electrically charges said at least one battery.

2. The electronic system of claim 1, further comprising a mobile communication device in electrical communication with said at least one battery.

3. The electronic system of claim 1, further comprising a mobile communication device in electrical communication with said at least one battery, and a wireless router.

4. The electronic system of claim 1, further comprising a mobile communication device in electrical communication with said at least one battery, and a wireless router; wherein said wireless router modifies a transmission signal to enhance energy harvesting of the at least one energy harvesting device.

5. The electronic system of claim 1, further comprising a mobile communication device in electrical communication with said at least one battery, and a wireless router; wherein said wireless router transmits a transmission signal to enhance energy harvesting of the at least one energy harvesting device.

6. The electronic system of claim 1, further comprising a mobile communication device in electrical communication with said at least one battery, and a wireless router; wherein said mobile communication device sends a signal to said wireless router to increase wireless transmission output of the wireless router.

7. The electronic system of claim 1, further comprising a mobile communication device in electrical communication with said at least one battery, and a wireless router; wherein said at least one energy harvesting device is integrated into said at least one battery.

8. The electronic system of claim 1, further comprising a mobile communication device in electrical communication with said at least one battery, and a wireless router; wherein said at least one energy harvesting device is integrated into said mobile communication device.

9. The electronic system of claim 1, further comprising a mobile communication device in electrical communication with said at least one battery, and a wireless router; wherein said at least one energy harvesting device is embodied in a detachable mobile communication device peripheral.

10. The electronic system of claim 1, further comprising a mobile communication device in electrical communication with said at least one battery, and a wireless router; wherein said at least one energy harvesting device is embodied in a plug and play mobile communication device peripheral.

11. An electronic system comprising:
at least one battery,
at least one energy harvesting device in electrical communication with said at least one battery,
at least one mobile communication device in electrical communication with said at least one battery,
at least one wireless router,
wherein said at least one energy harvesting device electrically charges said at least one battery.

12. The electronic system of claim 11, wherein said wireless router modifies a transmission signal to enhance energy harvesting of the at least one energy harvesting device.

13. The electronic system of claim 11, wherein said wireless router transmits a transmission signal to enhance energy harvesting of the at least one energy harvesting device.

14. The electronic system of claim 11, wherein said mobile communication device sends a signal to said wireless router to increase wireless transmission output of the wireless router.

15. The electronic system of claim 11, wherein said at least one energy harvesting device is integrated into said at least one battery.

16. The electronic system of claim 11, wherein said at least one energy harvesting device is integrated into said mobile communication device.

17. The electronic system of claim 11, wherein said at least one energy harvesting device is embodied in a detachable mobile communication device peripheral.

18. The electronic system of claim 11, wherein said at least one energy harvesting device is embodied in a detachable mobile communication device peripheral.

19. The electronic system of claim 11, wherein said at least one energy harvesting device is embodied in a plug and play mobile communication device peripheral.
